(19) United States
(12) Patent Application Publication
(10) Pub. No.: US 2026/0162572 A1
(43) Pub. Date: Jun. 11, 2026

(54) VEHICLE DISPLAY DEVICE

(71) Applicant: Yazaki Corporation, Tokyo (JP)

(72) Inventors: Yuta MIYAKE, Shizuoka (JP); Hiroshi SANO, Shizuoka (JP)

(73) Assignee: Yazaki Corporation, Tokyo (JP)

(21) Appl. No.: 19/411,623

(22) Filed: Dec. 8, 2025

(30) Foreign Application Priority Data
Dec. 10, 2024 (JP) 2024-215188

(51) Int. Cl. G09G 3/00; G02B 27/01; G06T 5/80

(52) U.S. Cl. CPC G09G 3/003; G02B 27/0149; G06T 5/80; G02B 2027/0159; G09G 2340/0492; G09G 2380/10

(57) ABSTRACT

A vehicle display device includes: an image generating unit configured to generate a display content; a display device configured to emit display light corresponding to the display content generated by the image generating unit; a first mirror and a second mirror configured to reflect and project the display light onto a windshield; a tilt information acquiring unit configured to acquire tilt information of the display content; and a rotation information acquiring unit configured to acquire rotation information of the display content. The image generating unit generates the display content by correcting the display content in accordance with the tilt information acquired by the tilt information acquiring unit and the rotation information acquired by the rotation information acquiring unit.

### CROSS-REFERENCE TO RELATED APPLICATION(S)

The present application claims priority to and incorporates by reference the entire contents of Japanese Patent Application No. 2024-215188 filed in Japan on Dec. 10, 2024.

### BACKGROUND OF THE INVENTION

### 1. Field of the Invention

The present invention relates to a vehicle display device.

### 2. Description of the Related Art

Conventionally, a vehicle display device, for example, described in Japanese Patent Application Laid-open No. JP 2018-159 882 A has been known. The vehicle display device is configured to generate a display content, project the display content in the form of display light onto a windshield, and allow the display content to be visually recognized as a virtual image. This device tilts the virtual image along a road surface by correcting the display content, for example, and displays the virtual image.

There is room for improvement in the above-mentioned vehicle display device, because the device sometimes causes a viewer such as a driver to have a feeling of unnaturalness about the virtual image. For example, when a virtual image is rotated in the direction of width of a vehicle with respect to the direction of travel of the vehicle and recognized, a risk of distortion of the virtual image is incurred at the time when the virtual image is tilted along a road surface. Thus, the virtual image sometimes appears unnatural due to this distortion.

### SUMMARY OF THE INVENTION

Therefore, an object of the present invention is to provide a vehicle display device capable of properly displaying a virtual image.

A vehicle display device according to one aspect of the present invention includes an image generating unit configured to generate a display content; a display device configured to emit display light corresponding to the display content generated by the image generating unit; a reflection unit configured to reflect and project the display light onto a display member; a tilt information acquiring unit configured to acquire tilt information of the display content; and a rotation information acquiring unit configured to acquire rotation information of the display content, wherein the image generating unit generates the display content by correcting the display content in accordance with the tilt information acquired by the tilt information acquiring unit and the rotation information acquired by the rotation information acquiring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a vehicle in which a vehicle display device according to an embodiment is installed;

FIG. 2 is a diagram illustrating an outline of the vehicle display device according to the embodiment;

FIG. 3 is a block diagram illustrating an outline of the electrical configuration of the vehicle display device according to the embodiment;

FIGS. 4A, 4B, and 4C are diagrams to explain image generation in the vehicle display device according to the embodiment;

FIGS. 5A, 5B, and 5C are diagrams to explain virtual images in the vehicle display device according to the embodiment; and

FIG. 6 is a flowchart illustrating image display processing in the vehicle display device according to the embodiment.

### DETAILED DESCRIPTION OF THE PREFERRED EMBODIMENTS

Hereinafter, an embodiment according to the present invention will be described in detail with reference to the drawings. Note that the present invention is not intended to be limited by the embodiment. In addition, constituents in the embodiment described below include those that the person skilled in the art can simply substitute or those that are substantially the same as the constituents.

### Embodiment

The present embodiment relates to a vehicle display device. In the following description, a first direction and a second direction intersect with each other, the first direction is referred to as “the front-and-rear direction X”, and the second direction as “the height direction Z”. Here, the front-and-rear direction X is perpendicular to the height direction Z. The front-and-rear direction X corresponds to a direction along the direction of travel of a vehicle. The expression, being perpendicular to, as used herein includes being substantially perpendicular to.

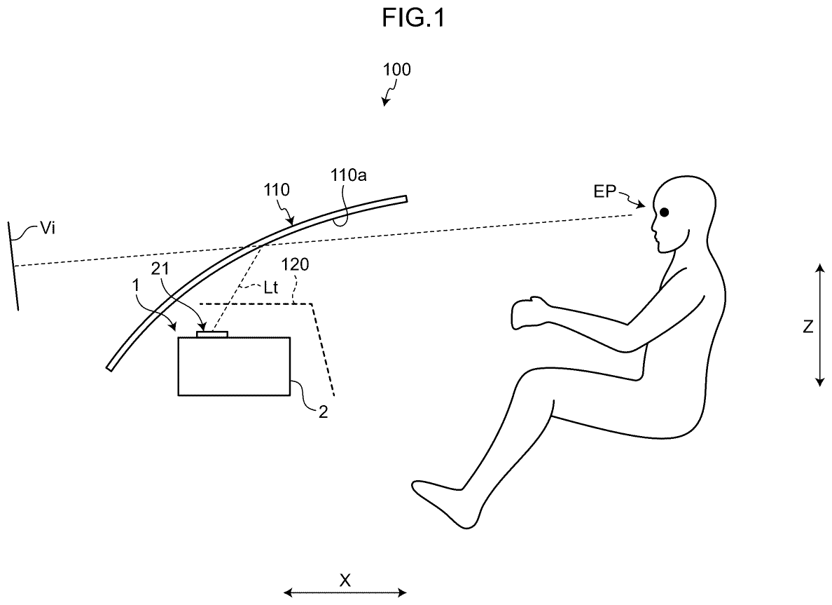

As illustrated in FIG. 1, a vehicle display device 1 according to the present embodiment is a head-up display device installed in a vehicle 100 such as an automobile. The vehicle display device 1, for example, projects display light Lt of an image onto a windshield 110. The windshield 110 is a display member onto which the display light Lt is projected. The windshield 110 is positioned forward of an eye point EP in the vehicle 100 and faces the eye point EP in the front-and-rear direction X of the vehicle. The display light Lt is reflected off a reflection surface 110a of the windshield 110 toward the eye point EP. A driver of the vehicle 100 can visually recognize a virtual image Vi through the display light Lt.

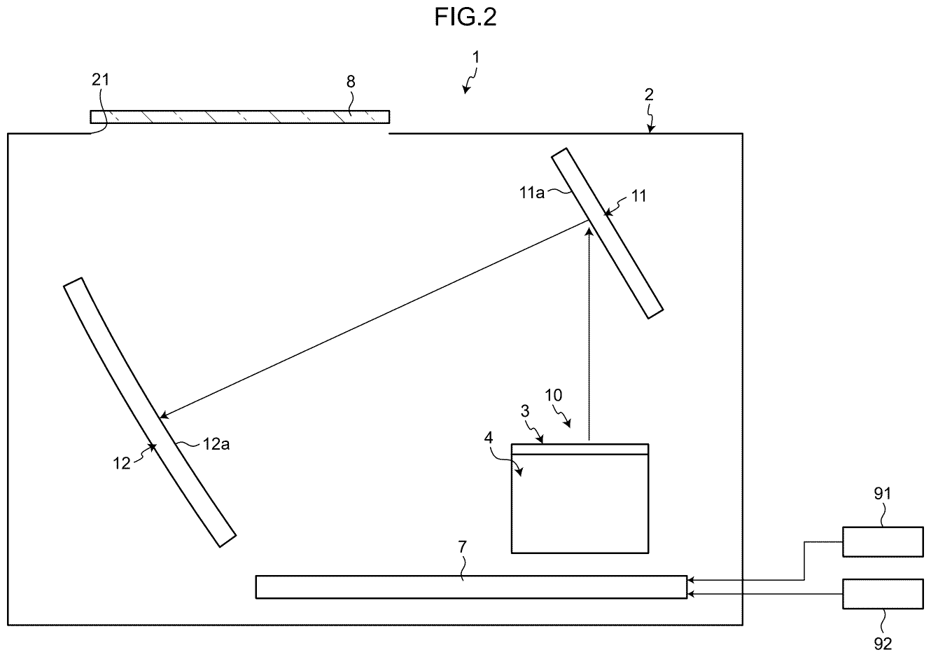

As illustrated in FIG. 1 and FIG. 2, the vehicle display device 1 includes, for example, a casing 2, an image display device 10, a control unit 7, a first mirror 11, a second mirror 12, and a cover 8. The casing 2 is disposed forward of the eye point EP in the vehicle and accommodated in an instrument panel 120, for example. The casing 2 is an outer shell member of the vehicle display device 1 and is fixed to a body of the vehicle 100. The casing 2 is made of a light-shielding material such as metal or resin. The casing 2 includes an opening 21 facing the windshield 110 in the height direction Z of the vehicle. The illustrated opening 21 is provided in the upper surface of the casing 2 and positioned at the front end of the casing 2. The first mirror 11 and the second mirror 12 function as reflection units configured to reflect the display light Lt. The display light Lt emitted from the image display device 10 is reflected off a reflection surface 11a of the first mirror 11, and the display light Lt reflected by the first mirror 11 is reflected off a reflection surface 12a of the second mirror 12 toward the cover 8. The cover 8 is a translucent member configured to cover the opening of the casing 2. The display light Lt is projected onto the windshield 110 through the cover 8.

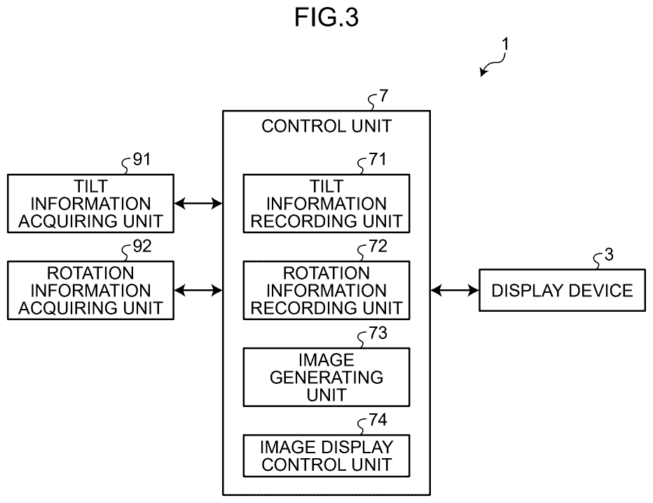

The image display device 10, the control unit 7, the first mirror 11, and the second mirror 12 are disposed inside the casing 2. The image display device 10 is a device configured to output the display light Lt corresponding to an image of the display content. As illustrated in FIG. 2 and FIG. 3, the image display device 10 includes a display device 3 and a backlight unit 4.

The display device 3 is a liquid crystal display such as a thin film transistor-liquid crystal display (TFT-LCD). The display device 3 includes a display surface and a back surface. The display surface is a surface on which an image is displayed and from which the display light Lt is output. The back surface is a surface opposed to the display surface. The shape of the display device 3 in the plan view is rectangular, for example.

The backlight unit 4 is a device configured to illuminate light to the back surface of the display device 3. The image display device 10 generates the display light Lt by using the light of the backlight unit 4. The backlight unit 4 includes a light source. The light source includes, for example, a plurality of light-emitting elements disposed in the lengthwise direction of an image and the crosswise direction of the image. The backlight unit 4 may include a lens configured to collect light of the light-emitting elements and a diffusion member configured to diffuse the collected light. The light source is disposed to face the back surface of the display device 3. The shape of the light source in the plan view is rectangular, for example.

The control unit 7 is a device configured to control the image display device 10 and includes a computer including, for example, an arithmetic unit, a memory, and a communication interface. The control unit 7, for example, executes the later-described image display control in accordance with a computer program stored in the memory.

The control unit 7 is connected to a tilt information acquiring unit 91 and a rotation information acquiring unit 92. The tilt information acquiring unit 91 and the rotation information acquiring unit 92 are disposed outside the casing 2, for example. The tilt information acquiring unit 91 acquires tilt information with respect to the front-and-rear direction of the vehicle, for example, acquires information on the gradient or tilt of a road surface on which the vehicle travels with respect to the direction of travel of the vehicle. Examples of the tilt information acquiring unit 91 include: a sensor configured to detect the gradient of a road surface by an image obtained by imaging the surrounding of the vehicle; a sensor configured to detect the gradient of the road surface, based on the posture of the vehicle; and an advanced driver-assistance system capable of acquiring information on the gradient of the road surface from map data, based on the location of the traveling vehicle. The rotation information acquiring unit 92 acquires information on the rotation of a virtual image, and examples of the rotation information acquiring unit 92 include an input device configured to acquire information on virtual image rotation operation instructed by a user such as a driver. The tilt information acquiring unit 91 and the rotation information acquiring unit 92 may be devices other than the sensors, system, and device described above, as long as the devices are capable of acquiring tilt information or rotation information. The tilt information acquiring unit 91 and the rotation information acquiring unit 92 may be disposed inside the casing 2.

As illustrated in FIG. 3, the control unit 7 includes a tilt information recording unit 71, a rotation information recording unit 72, an image generating unit 73, and an image display control unit 74. The tilt information recording unit 71 records the tilt information input from the tilt information acquiring unit 91. For example, the tilt information recording unit 71 records the tilt information input from the tilt information acquiring unit 91 as occasion arises, and updates the tilt information. The rotation information recording unit 72 records the rotation information input from the rotation information acquiring unit 92. For example, the rotation information recording unit 72 records the rotation information input from the rotation information acquiring unit 92 and updates the rotation information.

The image generating unit 73 generates a display content V, based on the tilt information acquired by the tilt information acquiring unit 91 and the rotation information acquired by the rotation information acquiring unit 92. That is, the image generating unit 73 generates the display content V, based on the tilt information acquired by the tilt information recording unit 71 and the rotation information acquired by the rotation information recording unit 72. For example, the display content V is generated by correcting a preset image, based on the tilt information and the rotation information. In other words, when there is neither tilt information nor rotation information, the display content V is generated, based on the preset image, whereas, when there is tilt information or rotation information, the display content V is generated by correcting the preset image in accordance with the tilt information or the rotation information. The preset image indicates the direction of travel of the vehicle, for example. More specifically, the preset image is an arrow indicating the direction of travel of the vehicle.

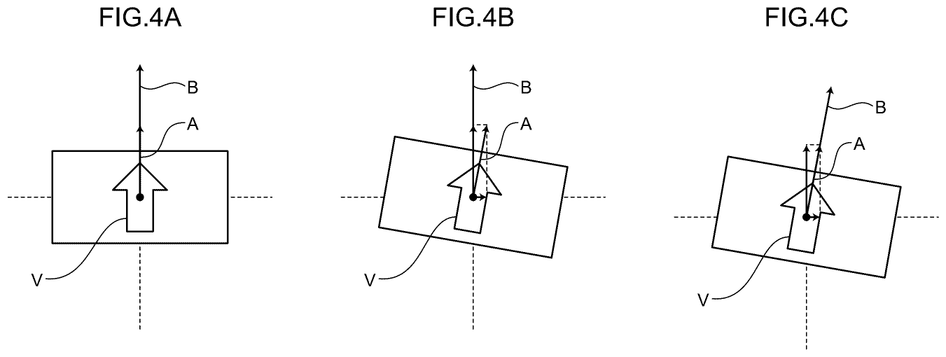

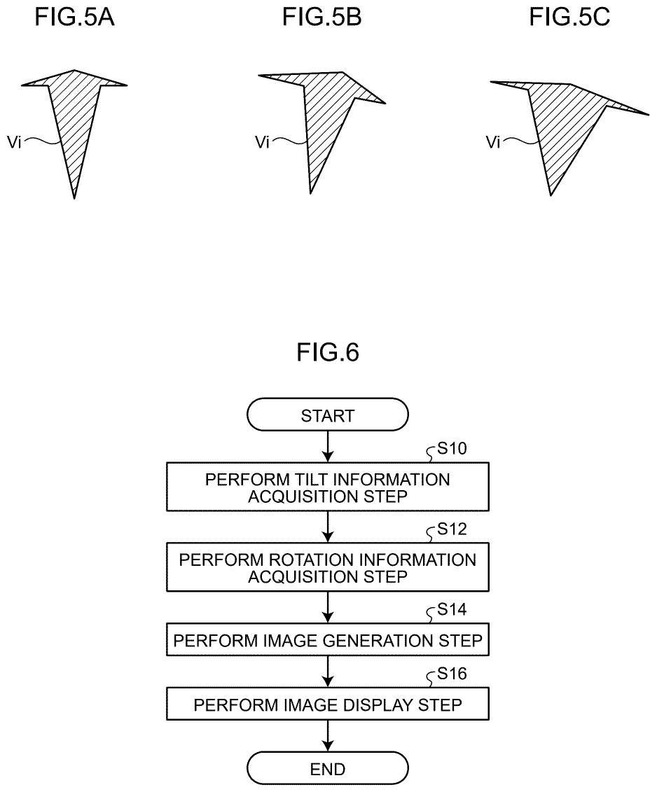

As illustrated in FIGS. 4A to 5C, the display content V is an arrow image and is generated in a state or shape of being tilted at a predetermined tilt angle toward the direction of travel of the vehicle to express a tilt sensation. As a result, the display content V is displayed and recognized as a virtual image Vi of an arrow oriented along a road surface (see FIG. 4A).

In FIG. 4A, a display content V generated when rotation correction is not performed in the vehicle display device 1 according to the present embodiment is illustrated. In FIG. 4B, a display content V generated when rotation correction is performed in a vehicle display device of a comparative example is illustrated. In FIG. 4C, a display content V generated when rotation correction is performed in the vehicle display device 1 according to the present embodiment is illustrated. In FIG. 5A, a virtual image Vi generated when rotation correction is not performed in the vehicle display device 1 according to the present embodiment is illustrated. In FIG. 5B, a virtual image Vi generated when rotation correction is performed in the vehicle display device of the comparative example is illustrated. In FIG. 5C, a virtual image Vi generated when rotation correction is performed in the vehicle display device 1 according to the present embodiment is illustrated.

When the road surface is a downhill or uphill slope, the display content V is corrected based on the tilt information, so that the virtual image Vi in the form of an arrow oriented along the road surface as illustrated in FIG. 4A is corrected to cause the tip of the arrow of the virtual image Vi to face upward or downward.

When the virtual image Vi is rotated in the direction of width of the vehicle, based on the rotation information, the display content V is rotationally corrected in an orientation and at a rotation angle in accordance with the rotation information. For example, as illustrated in FIG. 4C, the display content V rotates clockwise at a rotation angle in accordance with the rotation information. Here, not only a rotation vector A of the display content V, but also a tilt sensation vector B thereof are rotated together with the display content V. Thus, the virtual image Vi is visually recognized with less distortion and never or hardly ever appears unnatural.

The rotation vector A indicates a rotational position of the display content V. For example, when the rotation information indicates a rotation angle of zero, the rotation vector A is oriented to the direction of travel of the vehicle. In FIGS. 4A to 4C, the upward direction is set as the direction of travel of the vehicle. When the rotation information indicates clockwise rotation, the rotation vector A is oriented in the clockwise direction with respect to the direction of travel of the vehicle, and the display content V is rotationally corrected along the rotation vector A.

The tilt sensation vector B indicates the direction of tilt when the display content V is tilted. For example, when the rotation information indicates a rotation angle of zero, the tilt sensation vector B is oriented to the direction of travel of the vehicle. When the rotation information indicates clockwise rotation, the tilt sensation vector B is oriented to the clockwise direction with respect to the direction of travel of the vehicle, and the display content V is corrected to be tilted along the tilt sensation vector B.

For example, when only the display content V is rotated and the tilt sensation vector B is not rotated as illustrated in FIG. 4B, the virtual image Vi becomes distorted and appears unnatural (see FIG. 5B). In other words, even when the display content V is rotated from the direction of travel of the vehicle in accordance with the rotation information, as long as the tilt sensation vector B remains along the direction of travel of the vehicle, the virtual image Vi based on the display content V is distorted and appears unnatural. In contrast, in the case of rotating the display content V, the vehicle display device 1 according to the present embodiment rotates the tilt sensation vector B together with the rotation vector A of the display content V and thereby allows the virtual image Vi to be visually recognized with less distortion as illustrated in FIG. 5C.

In FIG. 3, the image display control unit 74 exercises control so that the display content V generated by the image generating unit 73 is displayed as the virtual image Vi. For example, the image display control unit 74 sends an image signal of the display content V to the display device 3, whereby an image is displayed by the display device 3. The image displayed by the display device 3 is emitted as the display light Lt from the image display device 10. The display light Lt is then projected onto the windshield 110 and is visually recognized as the virtual image Vi by a vehicle driver.

Next, an operation of the vehicle display device 1 according to the present embodiment will be described.

FIG. 6 is a flowchart illustrating an operation of the vehicle display device 1. A series of steps for control processing illustrated in the flowchart in FIG. 6 is executed by the control unit 7 and initiated by turning on a power switch of the vehicle, switching on ignition, or turning on the power source of vehicle display device 1, for example. The control processing illustrated in the flowchart in FIG. 6 is repeated until the operation of the vehicle display device 1 is completed, for example.

In the operation of the vehicle display device 1, first, a tilt information acquisition step is performed at step S10 in FIG. 6 (hereinafter, simply referred to as S10. The same applies to the steps performed after S10). The tilt information acquisition step is the step of reading tilt information input from the tilt information acquiring unit 91, and is performed by the tilt information recording unit 71, for example.

The control processing then proceeds to S12 to perform a rotation information acquisition step. The rotation information acquisition step is the step of reading rotation information input from the rotation information acquiring unit 92, and is performed by the rotation information recording unit 72, for example.

The control processing then proceeds to S14 to perform an image generation step. The image generation step is the step of generating a display content V. The display content V is generated by correcting an image preset in the control unit 7, in accordance with the tilt information read through the tilt information acquisition step at S10 and the rotation information read through the rotation information acquisition step at S12. For example, when the vehicle continuously travels on a flat road, there is no change in tilt information and accordingly the display content V is generated without tilt correction. When there is no rotation information input from the rotation information acquiring unit 92, the display content V is generated without rotation correction.

For example, when the vehicle enters an uphill or downhill road from a flat road, the display content V is generated by tilt correction in accordance with the tilt information. When the rotation information input from the rotation information acquiring unit 92 is clockwise or counterclockwise rotation information, the display content V is generated by rotation correction. In other words, as illustrated in FIG. 4C, the display content V is generated by correction based on the rotation vector A and the tilt sensation vector B rotated in accordance with the rotation information. Here, as illustrated in FIGS. 5A to 5C, when the virtual image Vi is displayed in the state of being tilted along the road surface, the display content V is generated by correction based on the rotation vector A and the tilt sensation vector B rotated in accordance with the rotation information, even when there is no change in the tilt information. Thus, the display content V is generated by correction based on the rotation vector A and the tilt sensation vector B rotated in accordance with the rotation information, whereby the virtual image Vi with less distortion can be displayed.

In FIG. 6, the control processing then proceeds to S16 to perform an image display step. The image display step is the step of sending the display content V generated at S14 to the display device 3 and displaying the virtual image Vi corresponding to the display content V. That is, the control unit 7 outputs an image signal of the display content V to the display device 3. The display device 3 displays an image of the display content V, and the image displayed by the display device 3 is emitted in the form of the display light Lt from the image display device 10, projected onto the windshield 110, and is visually recognized as the virtual image Vi by a user such as a vehicle driver.

As described above, the vehicle display device 1 according to the present embodiment generates a display content V by correction based on the tilt information and the rotation information of the display content V and thereby can adjust a tilt sensation in accordance with the amount of rotation of the display content. Thus, the vehicle display device 1 according to the present embodiment can perform the rotation with reduced distortion of the virtual image Vi in a tilted state and can properly display the virtual image Vi corresponding to the display content V.

The vehicle display device 1 according to the present embodiment generates the display content V intended to indicate the direction of travel of the vehicle, and generates the display content V by correction in accordance with the information on rotation with respect to the direction of width of the vehicle. When rotating the virtual image Vi with respect to the direction of width of the vehicle and displaying the virtual image Vi, the vehicle display device 1 according to the present embodiment can properly display the virtual image Vi corresponding to the display content V.

Furthermore, when correcting the display content V in accordance with rotation information, the vehicle display device 1 according to the present embodiment rotates both the rotation vector A indicating the rotational position of the display content V and the tilt sensation vector B indicating the direction of tilt of the display content V, in accordance with the rotation information, and corrects the display content V, based on the rotation vector A and the tilt sensation vector B. Thus, the vehicle display device 1 according to the present embodiment can further reduce distortion of the virtual image Vi corresponding to the display content V, and can more properly display the virtual image Vi corresponding to the display content V, compared to the case of performing only the rotation correction of the display content V.

Note that the vehicle display device according to the present invention is not limited to the embodiment described above, and various modifications can be made to the vehicle display device within the scope described in the appended claims. The vehicle display device 1 according to the present invention may be configured by suitably combining the constituents in the embodiment or modifications described above.

For example, in the vehicle display device 1 according to the present embodiment described above, the display content V is an arrow image an indicating the direction of travel of a vehicle, but the display content V may be an image other than the arrow image to allow the virtual image Vi to be visually recognized.

With the vehicle display device according to the present embodiment, a virtual image can be properly displayed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
an image generating unit configured to generate a display content;
a display device configured to emit display light corresponding to the display content generated by the image generating unit;
a reflection unit configured to reflect and project the display light onto a display member;
a tilt information acquiring unit configured to acquire tilt information of the display content; and
a rotation information acquiring unit configured to acquire rotation information of the display content, wherein
the image generating unit generates the display content by correcting the display content in accordance with the tilt information acquired by the tilt information acquiring unit and the rotation information acquired by the rotation information acquiring unit.

2. The vehicle display device according to claim 1, wherein
the display content indicates a direction of travel of a vehicle, and
the rotation information acquiring unit acquires the rotation information with respect to a direction of width of the vehicle.

3. The vehicle display device according to claim 1, wherein
when correcting the display content in accordance with the rotation information, the image generating unit rotates both a rotation vector indicating a rotational position of the display content and a tilt sensation vector indicating a direction of tilt of the display content in accordance with the rotation information, and corrects the display content based on the rotation vector and the tilt sensation vector.

4. The vehicle display device according to claim 2, wherein
when correcting the display content in accordance with the rotation information, the image generating unit rotates both a rotation vector indicating a rotational position of the display content and a tilt sensation vector indicating a direction of tilt of the display content in accordance with the rotation information, and corrects the display content based on the rotation vector and the tilt sensation vector.
